(19) United States
(12) Patent Application Publication
(10) Pub. No.: US 2015/0128603 A1
(43) Pub. Date: May 14, 2015

(54) GAS-TURBINE COMBUSTION CHAMBER AND METHOD FOR ITS MANUFACTURE

(71) Applicant: Rolls-Royce Deutschland Ltd & Co KG, Blankenfelde-Mahlow (DE)

(72) Inventors: Carsten CLEMEN, Mittenwalde (DE); Miklós GERENDÁS, Am Mellensee (DE); Michael EBEL, Rangsdorf (DE); Stefan PENZ, Werneuchen (DE)

(21) Appl. No.: 14/538,254

(22) Filed: Nov. 11, 2014

(30) Foreign Application Priority Data
Nov. 11, 2013 (DE) 10 2013 222 863.5

(51) Int. Cl. B23K 26/34; F23R 3/04; F23R 3/00

(52) U.S. Cl. CPC B23K 26/345; F23R 3/002; F23R 3/04; F23R 2900/03044; F23R 2900/00018; B33Y 10/00
USPC 60/758; 60/752; 219/76.14

(57) ABSTRACT

The present invention relates to a gas-turbine combustion chamber having a head plate and an outer and an inner combustion chamber wall, characterized in that the combustion chamber is designed in one piece by means of a DLD method, or is assembled from segments which are welded to one another and manufactured in one piece by means of a DLD method, as well as to a method for manufacturing the gas-turbine combustion chamber.

### CROSS-REFERENCE TO RELATED APPLICATION

This application claims priority to German Patent Application DE102013222863.5 filed Nov. 11, 2013, the entirety of which is incorporated by reference herein.

### BACKGROUND

A variety of different embodiments of gas-turbine combustion chambers are known from the state of the art, which are however all designed to the same basic principle, where a combustion chamber outer wall is provided which is produced from a formed sheet metal. Impingement cooling holes are made in this outer combustion chamber wall, usually by means of a boring process. Tiles are fastened to the outer combustion chamber wall and fixed by means of bolts and screws. An inner combustion chamber wall is designed in the same way. For suspension of the combustion chamber, flanges connected to a combustion chamber suspension are used. These parts are for example manufactured as separate forgings and welded to the outer or inner combustion chamber wall, respectively. A combustion chamber head, a head plate and a heat shield are also each manufactured as separate components, mostly as castings. The necessary cooling holes in the heat shield are also made by means of a boring process, like air supply holes in the head plate. The combustion chamber casing is connected to the heat shield and the combustion chamber head as well as to the head plate, partly by means of bolted connections and partly by welding.

The result is that the method of manufacture known from the state of the art requires a very large number of individual parts and involves very high expenditure for its production. In particular, the many components require many different production methods with many production steps. This furthermore results in the disadvantage that inaccuracies and dimensional divergences accumulate during production. The need to provide a plurality of cooling air holes in the combustion chamber wall and the tiles also results in high additional production expenditure. All this leads to very high costs for the manufacture of a gas-turbine combustion chamber too.

### SUMMARY

An object underlying the present invention is to provide a gas-turbine combustion chamber and a method for its manufacture, which, while being simply designed and easily applicable, reduce the required production expenditure, increase manufacturing precision of the combustion chamber and lead to a significant cost reduction.

In accordance with the invention, the problem is solved by a gas-turbine combustion chamber having a head plate and an outer and an inner combustion chamber wall, where the latter can be of the single-wall or double-wall design, i.e. with the tile function integrated into the combustion chamber wall and the tile being designed in one piece by means of a DLD method. Accordingly, it is provided, with regard to the method for manufacturing the combustion chamber, that the latter is made in one piece at least with the head plate and with the outer and the inner combustion chamber wall by means of the DLD (direct laser deposition) method.

In a particularly favourable embodiment of the invention, it is provided that the combustion chamber has a U-shaped cross-section and is either manufactured in one piece by means of the DLD method or is assembled from individual segments of U-shaped cross-section which are welded to one another and are each manufactured by means of the DLD method. These segments expediently include at least one combustion chamber sector, but can also extend over several sectors, where the recurrent division on the basis of the fuel nozzles is defined as the combustion chamber sector.

With the DLD method to be used in accordance with the invention, a powdery basic material usually consisting of metallic components is melted on, layer by layer, by means of a laser or an electron beam, so that a three-dimensional workpiece is produced which is of high precision and requires only minor reworking or none at all. Using the DLD method, it is in particular possible to produce highly complex geometries with recesses, cavities and/or undercuts in a way that would not be possible with conventional production, or if so only to a very limited extent.

In a particularly favourable development of the invention, it is provided that at least one combustion chamber flange and/or one combustion chamber suspension is manufactured in one piece with the combustion chamber by means of the DLD method. It can be favourable here to manufacture the combustion chamber flange and/or the combustion chamber suspension with an allowance, and then to finish-machine it to suit the installation situation.

With a design of the gas-turbine combustion chamber in accordance with the invention using individual segments of a U-shaped cross-section, it can be advantageous to provide at the joining areas of the segments web-like areas which provide an additional material volume for the subsequent welding operation. It is thus not required during joining of the individual segments to supply additional material, thus leading to a substantial simplification of the welding method.

The joining lines can here be in one plane, which is advantageous from the viewpoint of production, but it is also conceivable to match the separation points of the sectors to the traditional design rules for tiles, which make no provision for separation lines through mixing holes. The resultant joining lines represent a line which is more or less curved in the circumferential direction and can be in the opposing direction on the top and bottom sides.

In accordance with the invention, cooling air holes, holes for fastening points, admixing holes, holes for igniter plugs and/or holes for sensors or the like are also manufactured by means of the DLD method. Further additional machining steps can therefore be dispensed with entirely. It is furthermore possible to create the individual holes or recesses with any required cross-sections and any required orientation. This permits design measures that with conventional production methods would not be feasible, or if so only to a limited extent.

In a favourable development of the gas-turbine combustion chamber in accordance with the invention, it is possible either to design a combustion chamber head as a full ring and connect it to the gas-turbine combustion chamber, or to manufacture the combustion chamber head in segmented form. The head plate manufactured by means of the DLD method is preferably provided with positive-fitting positioning means (contact surfaces, key and slot surfaces and the like) to assure exact positioning of the combustion chamber head.

### BRIEF DESCRIPTION OF THE DRAWINGS

The present invention is described in the following in light of the accompanying drawing, showing exemplary embodiments. In the drawing,

FIG. 1 shows a gas-turbine engine for using the gas-turbine combustion chamber in accordance with the present invention,

FIG. 2 shows an enlarged, schematized detail sectional view of a combustion chamber in accordance with the state of the art,

FIG. 3 shows a view, by analogy with FIG. 2, of an exemplary embodiment of the combustion chamber in accordance with the present invention,

FIGS. 4, 5 show a front view and a side view of a combustion chamber segment in accordance with the present invention,

FIGS. 6 to 8 show representations of the joining areas of combustion chamber segments in accordance with the present invention,

FIG. 9 shows a front view and two side views of a heat shield in accordance with the present invention,

FIG. 10 shows an enlarged partial sectional view of the connection of a combustion chamber head in light of an exemplary embodiment of the combustion chamber in accordance with the present invention, and

FIG. 11 shows a representation of the joining area of combustion chamber segments.

### DETAILED DESCRIPTION

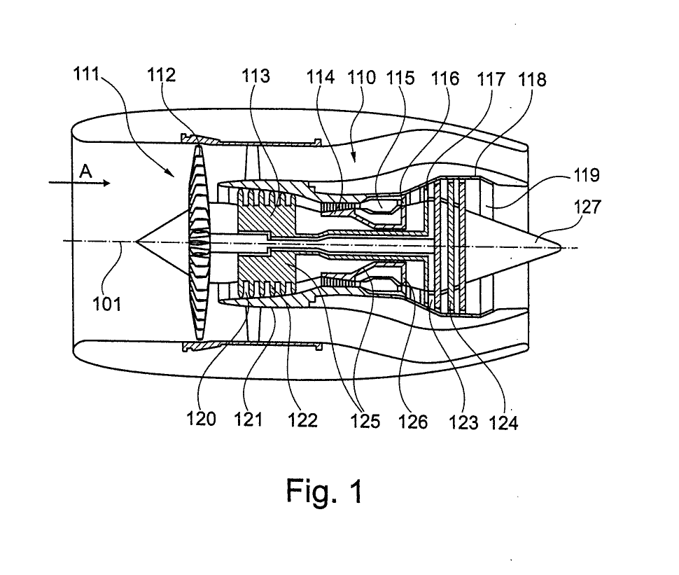

The gas-turbine engine 110 in accordance with FIG. 1 is a generally represented example of a turbomachine, where the invention can be used. The engine 110 is of conventional design and includes in the flow direction, one behind the other, an air inlet 111, a fan 112 rotating inside a casing, an intermediate-pressure compressor 113, a high-pressure compressor 114, a combustion chamber 115, a high-pressure turbine 116, an intermediate-pressure turbine 117 and a low-pressure turbine 118 as well as an exhaust nozzle 119, all of which being arranged about an engine center axis 101.

The intermediate-pressure compressor 113 and the high-pressure compressor 114 each include several stages, of which each has an arrangement extending in the circumferential direction of fixed and stationary guide vanes 120, generally referred to as stator vanes and projecting radially inwards from the engine casing 121 in an annular flow duct through the compressors 113, 114. The compressors furthermore have an arrangement of compressor rotor blades 122 which project radially outwards from a rotatable drum or disk 125 linked to hubs 126 of the high-pressure turbine 116 or the intermediate-pressure turbine 117, respectively.

The turbine sections 116, 117, 118 have similar stages, including an arrangement of fixed stator vanes 123 projecting radially inwards from the casing 121 into the annular flow duct through the turbines 116, 117, 118, and a subsequent arrangement of turbine blades 124 projecting outwards from a rotatable hub 126. The compressor drum or compressor disk 125 and the blades 122 arranged thereon, as well as the turbine rotor hub 126 and the turbine rotor blades 124 arranged thereon rotate about the engine center axis 101 during operation.

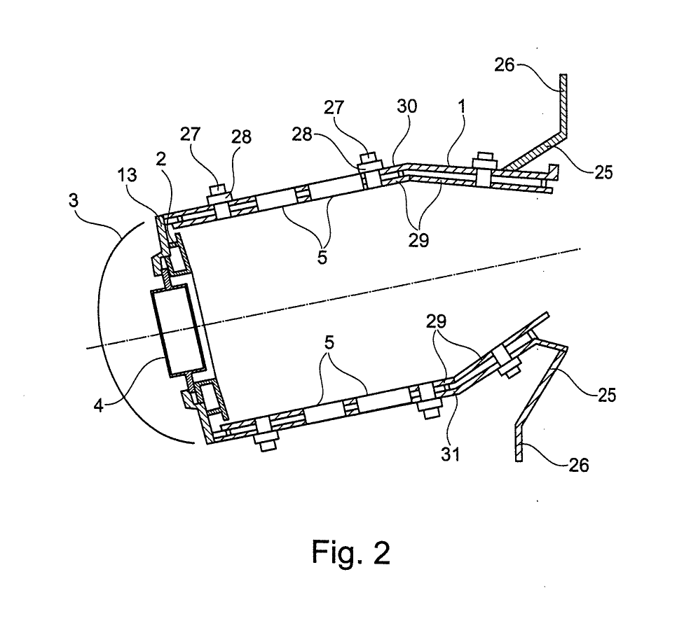

FIG. 2 shows in enlarged schematic representation a sectional view of a gas-turbine combustion chamber 1 in accordance with the state of the art. The combustion chamber includes a heat shield 2 and a combustion chamber head 3, which, like a burner seal 4, are manufactured as separate components. Furthermore, the combustion chamber 1 is provided with a head plate 13, which is also manufactured as a separate component. An outer combustion chamber wall 30 and an inner combustion chamber wall 31 adjoin the head plate 13. The combustion chamber walls 30 and 31 are made as separate parts from formed sheet metal and provided with bored impingement cooling holes. The combustion chamber 1 is suspended by means of a combustion chamber suspension 25 and combustion chamber flanges 26, which are also manufactured as separate parts, usually as forgings, and welded to the combustion chamber walls 30 and 31.

The combustion chamber head 3, the head plate 13 and the heat shield 2 are, as already mentioned, manufactured as separate components, usually by means of a casting process. In subsequent process steps, it is necessary to provide cooling holes, in particular in the heat shield. Air passage holes in the head plate 13 are also usually bored.

For thermal insulation of the outer and the inner combustion chamber wall 30, 31, tiles 29 are used which are manufactured individually and provided with effusion holes. The effusion holes are usually bored, while the tiles 29 are manufactured as castings. The tiles 29 are bolted by means of bolts 27 and nuts 28 to the outer and the inner combustion chamber wall 30, 31 or fastened in another way. The result is thus that a very complex structure using a plurality of individually manufactured structural elements is obtained. A considerable effort involving high costs is required for both the manufacture and the final assembly of the combustion chamber. In addition, dimensional inaccuracies of the individual components accumulate, requiring special additional measures to achieve precise dimensioning of the combustion chamber.

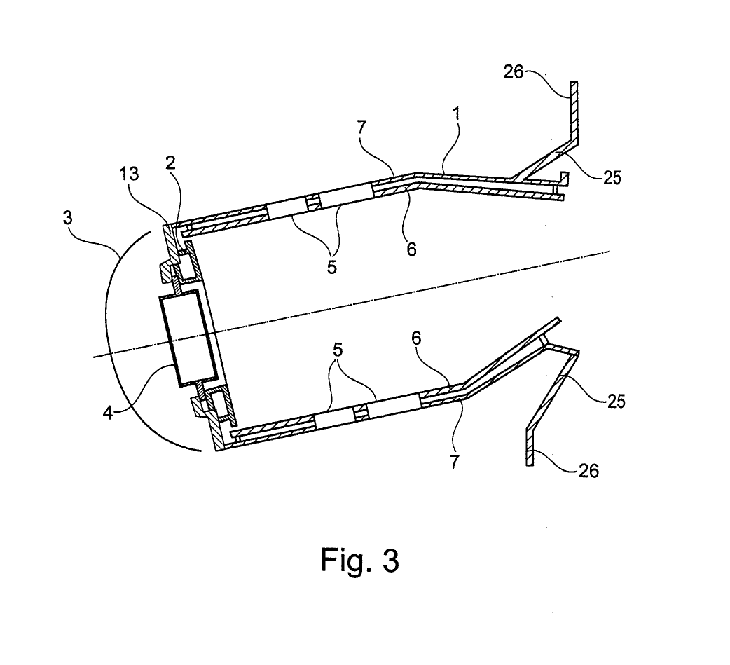

FIG. 3 shows a first exemplary embodiment of a combustion chamber 1 in accordance with the present invention, with identical parts being provided with the same reference numerals, as compared with the representation in accordance with FIG. 2.

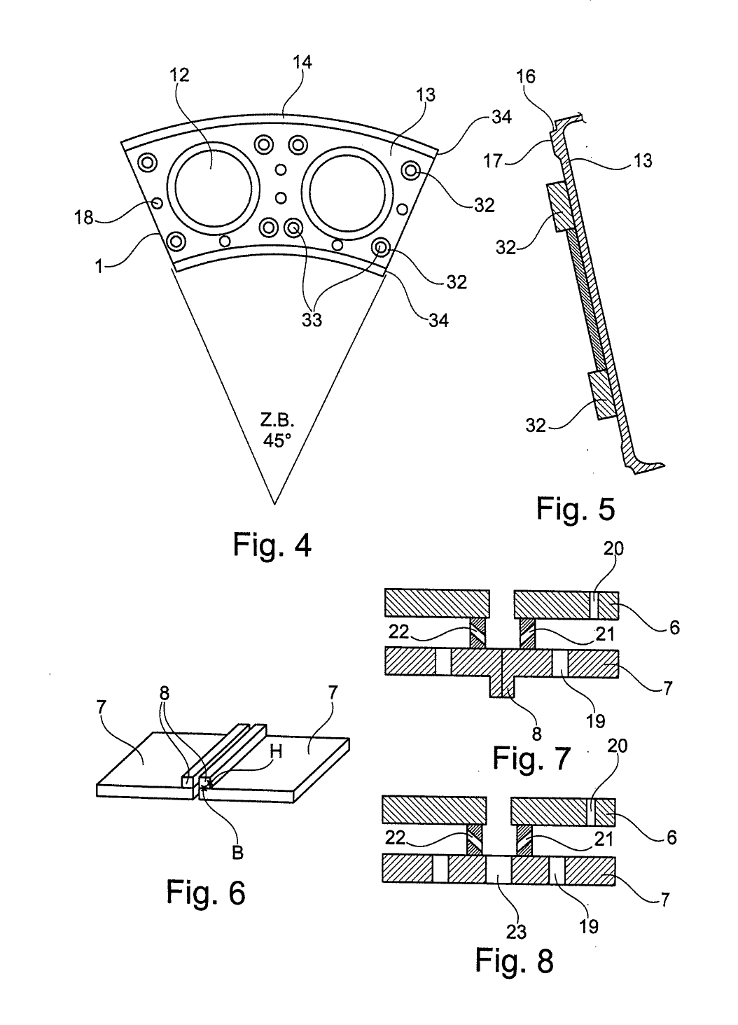

The combustion chamber 1 in accordance with the invention includes a single circumferential segment designed in the form of a full ring having a U-shaped cross-section. Alternatively, it is also possible to design the combustion chamber in the form of segments, as shown in FIGS. 4 and 5. The combustion chamber segments are then joined up to form a full ring, preferably by means of a laser welding method.

The combustion chamber has, as already mentioned, a U-shaped cross-section, as is shown in FIG. 3. Hence the head plate 13 is connected in one piece to an inner, hot combustion chamber wall 6 and to an outer, cold combustion chamber wall 7. The combustion chamber walls 6 and 7 have admixing holes 5. Due to the one-piece design of the inner, hot combustion chamber wall 6 and the outer, cold combustion chamber wall 7 at a distance from one another, a space is formed through which cooling air is passed. As can be seen from the sectional views of FIGS. 7 and 8, the hot combustion chamber wall 6 is provided with effusion holes 20, while impingement cooling holes 19 are formed in the cold combustion chamber wall 7. Connecting webs 21 are used to keep the two combustion chamber walls 6 and 7 apart, and are provided with weld cooling holes 22 for cooling a weld 23, yet to be described. The weld cooling holes 22 can also face alternately inwards and outwards for cooling the weld and the tile rim equally.

Combustion chamber suspensions 25 are provided in one piece on the respective cold combustion chamber wall 7, and merge in one piece into combustion chamber flanges 26. The combustion chamber suspension 25 and the combustion chamber flange 26 can be provided either on the inside or on the outside or on both sides of the combustion chamber 1.

FIG. 3 shows that the combustion chamber head 3, the burner seal 4 and the heat shield 2 are manufactured as separate components and assembled accordingly.

As a variant, the combustion chamber can, if the U-shaped cross-section is manufactured as a full ring, be provided with an integral head part, i.e. the combustion chamber head 3 and the combustion chamber walls 6 and/or 7 are designed in one piece and no longer represent separate parts.

In accordance with the invention, the combustion chamber 1 is manufactured by means of a DLD method, so that all impingement cooling holes 19, all effusion cooling holes 20 and all admixing holes 5 are created during this production process. The same applies for holes, not shown, for igniter plugs, instrumentation or other holes for cooling. The holes 18 in the head plate 13 are also created during the DLD manufacturing process. Hence it is not necessary in accordance with the invention to bore additional holes or manufacture them in another way.

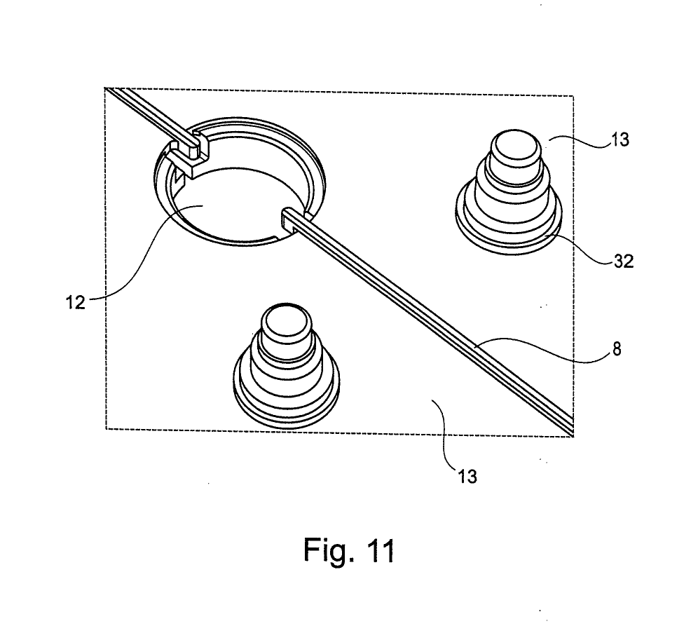

With a segmented embodiment (see FIGS. 4 and 5), the individual segments are welded together to form a full ring, preferably by means of a laser welding method, but conventional welding methods are also conceivable. The reference numeral 34 indicates joining surfaces. FIGS. 6 to 8 show in this connection that in accordance with the invention additional material areas 8 are provided which extend bead-like along the joining area and are also created by means of the DLD method. The additional material areas 8 are located on both sides of the joining area on the cold combustion chamber wall 7, and the dimensions can be for example 0.4 mm to 1.5 mm in width and in height. The additional material areas extend preferably over the entire length of the weld to be provided, as is shown in FIGS. 6 to 8. They can however also be designed projecting, as shown in FIG. 11. FIG. 7 shows the state before welding, while FIG. 8 shows the welded state with the weld 23. As mentioned, the weld cooling holes 22 in the connecting webs 21 are used to cool the weld 23. They can also have a different orientation for cooling the tile rim.

The linear embodiment of the weld without branches, with the thicknesses changing only gradually (not abruptly), is also advantageous for production. Intersecting welds such as, for example, between the outer combustion chamber wall and the arm of the suspension can be designed such that the necessary ventilation openings are at the separation line of the sectors and permit a continuous weld up to the point where the weld can be continued by re-positioning the welding tip.

To avoid an incidence of the weld at edges, for example at admixing holes, the additional material area can be extended beyond the actual workpiece geometry in order to prevent an otherwise unavoidable welding contact point on the finished component. This projecting additional material area is removed after the welding operation by minor machining that covers all imperfections.

As shown in FIG. 4, the head plate 13 has holes 33 for passing through bolts or heat shield pins. Furthermore, supporting elements 32 for the combustion chamber head 3 are provided. The head plate 13 is provided with holes 12 for the burner seal 4 in one piece during the DLD manufacturing process.

Due to the DLD production of the one-piece combustion chamber 1 in accordance with the invention, it is possible to design any required hole and duct shapes and any required sizes for holes or ducts, for example round, elliptical or rhomboidal. Furthermore, it is possible to provide the holes or ducts in any required orientation, for example perpendicular to the wall, inclined at any required angle to the wall, helical, and in differing orientations to the respective surfaces of the wall. This permits optimum cooling.

In the exemplary embodiments in accordance with the invention, it is provided that the heat shield 2, the combustion chamber head 3 and the burner seal 4 can be manufactured as separate parts with any required production methods, including not only DLD production, but also casting methods or MIM (metal injection moulding). The combustion chamber head 3 can be designed as a full ring or in segmented form, with the segmentation of the combustion chamber head 3 possibly differing from the segmentation of the combustion chamber 1.

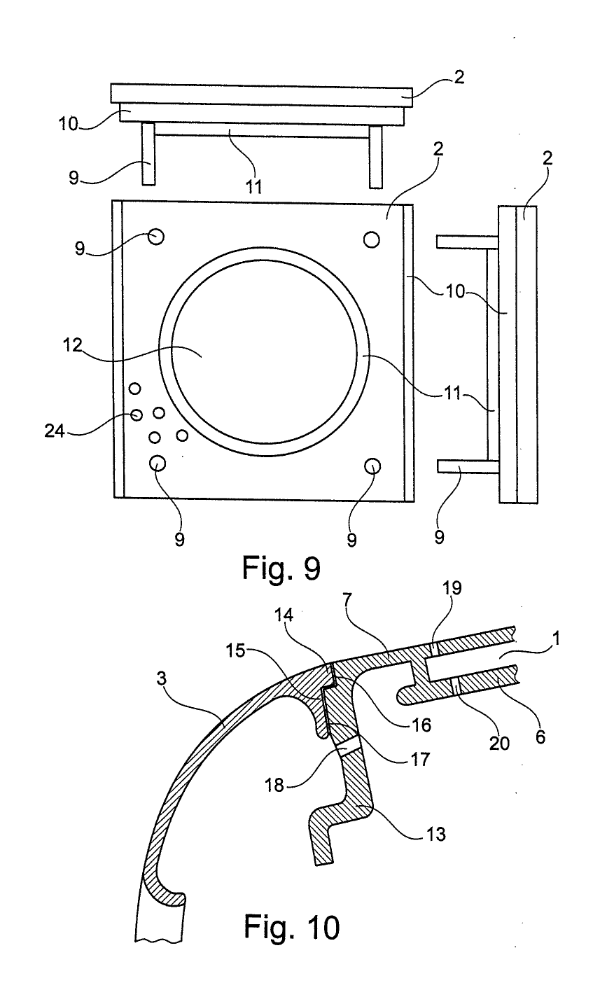

As shown in FIG. 9, the heat shield 2 has integrated bolts 9 that are passed through the passage in the head plate 13. The heat shield 2 can thus be bolted to the combustion chamber head 3 using a nut. Further components, such as for example a burner seal 4, are arranged between the heat shield 2, the combustion chamber head 3 and the head plate 13.

It is also possible in accordance with the invention for the heat shield to be manufactured as an integral part of the combustion chamber head. This is possible in both cases of the segmented U-shaped combustion chamber, i.e. without integrated head, and manufactured as a full ring, with and without integral head (FIG. 3, combustion chamber head 3 and combustion chamber wall 7). The burner seal 4 is then fastened by separate rings to be inserted from the front.

In the case of welded combustion chamber segments, the heat shield 2 additionally has an overhang 10 on both sides to the adjacent heat shield 2. This overhang 10 covers the weld connecting the head plates 13 behind. Furthermore, the heat shield 2 can have on its rear face a raised surface in the form of a support 11 surrounding the burner hole 12. This support is used for axial fixing and localization of the burner seal 4 during bolting to the burner head 3. Any number of cooling holes 24 of any required design can be provided in the heat shield 2.

FIG. 10 shows an exemplary embodiment for the connection of the combustion chamber head 3 to the combustion chamber 1. To do so, the combustion chamber head 3 has a key feature 14 and a support 15, which together with a groove 16 of the combustion chamber 1 contribute to exact positioning of the combustion chamber head 3. The support 15 contacts a supporting surface 17. The groove 16 and the supporting surface 17 on the head plate 13 (combustion chamber/combustion chamber segment) can be either unmachined, as resulting from the DLD method, or reworked to achieve a suitable surface finish.

The embodiment in accordance with the invention results in a considerable reduction in the number of individual parts. Furthermore, the combustion chamber in accordance with the invention has an improved overall tolerance and fewer structural divergences. The manufacturing process is much faster when compared with the state of the art. Overall the result is considerably reduced costs. The individual areas of the combustion chamber can, when compared with the state of the art, be provided with a far more complex and optimized cooling, in particular of the combustion chamber walls.

1. Gas-turbine combustion chamber having a head plate and an outer and an inner combustion chamber wall, characterized in that the combustion chamber is designed in one piece by means of a DLD method.

2. Gas-turbine combustion chamber having a head plate and an outer and an inner combustion chamber wall, characterized in that the combustion chamber is assembled from segments which are welded to one another and manufactured in one piece by means of a DLD method.

3. Gas-turbine combustion chamber in accordance with claim 1, wherein the latter has a U-shaped cross-section.

4. Gas-turbine combustion chamber in accordance with claim 1, wherein the latter is designed in one piece with at least one combustion chamber flange and/or one combustion chamber suspension.

5. Gas-turbine combustion chamber in accordance with claim 2, wherein web-like additional material areas are provided at the joining areas of the segments.

6. Gas-turbine combustion chamber in accordance with claim 1, wherein cooling air holes, holes for fastening elements, admixing holes, holes for igniter plugs and/or holes for sensors are manufactured by means of the DLD method.

7. Gas-turbine combustion chamber in accordance with claim 1, wherein a combustion chamber head is designed in segmented form or as a full ring.

8. Gas-turbine combustion chamber in accordance with claim 1, wherein the head plate is provided with positive-fitting positioning means for a combustion chamber head.

9. Method for manufacturing a combustion chamber of a gas turbine, where a head plate as well as an outer and an inner combustion chamber wall are manufactured in one piece by means of a DLD method.

10. Method in accordance with claim 9, wherein the combustion chamber is manufactured as a full ring or in the form of segments to be welded to one another.
